(19) United States
(12) Patent Application Publication
(10) Pub. No.: US 2017/0249678 A1
(43) Pub. Date: Aug. 31, 2017

(54) METHODS AND SYSTEMS FOR GENERATING AND UTILIZING CROWD-SOURCED PRODUCT CATALOGS

(71) Applicant: ELADY LTD., Tokyo (JP)

(72) Inventor: Nir PLATEK, Tokyo (JP)

(73) Assignee: ELADY LTD., Tokyo (JP)

(21) Appl. No.: 15/321,269

(22) PCT Filed: Jun. 23, 2015
(86) PCT No.: PCT/IL15/50644

§ 371 Date: Dec. 22, 2016

Related U.S. Application Data
(60) Provisional application No. 62/015,581, filed on Jun. 23, 2014.

(51) Int. Cl. G06Q 30/06; G06Q 10/10; G06Q 50/00

(52) U.S. Cl. CPC G06Q 30/0603; G06Q 30/0631; G06Q 50/01; G06Q 30/0605; G06Q 10/101

(57) ABSTRACT

A method for generating a crowd-sourced product catalog, the method including enabling any of a first multiplicity of individuals to generate, for non pre-cataloged items, structured, multi-language catalog entries in the crowd-sourced product catalog in a structured data format, and enabling any of a second multiplicity of individuals to employ any catalog entry existing in the crowd-sourced product catalog as a template for generating a modified catalog entry by modifying at least one parameter of the catalog entry.

### REFERENCE TO RELATED APPLICATIONS

Reference is made to U.S. Provisional Patent Application Ser. No. 62/015,581, filed Jun. 23, 2014 and entitled “METHODS AND SYSTEMS FOR CREATING AND UTILIZING CROWD-SOURCED PRODUCT CATALOGS”, the disclosure of which is hereby incorporated by reference and priority of which is hereby claimed pursuant to 37 CFR 1.78(a) (4) and (5)(i).

### FIELD OF THE INVENTION

The present invention relates to methods and systems for generating and utilizing a crowd-sourced product catalog.

### BACKGROUND OF THE INVENTION

Various methods and systems for generating and utilizing on-line product catalogs are known. Typically, such product catalogs are generated and maintained by a particular individual or entity. Potential contributors to the catalog typically need to submit new catalog entries to the catalog maintaining entity for posting. The present invention provides systems and methods for enabling contributors to on-line catalogs to employ and modify information existing in an on-line catalog to further enrich the catalog.

### SUMMARY OF THE INVENTION

The present invention seeks to provide improved methods and systems for generating and utilizing crowd-sourced product catalogs.

There is thus provided in accordance with a preferred embodiment of the present invention a method for generating a crowd-sourced product catalog, the method including enabling any of a first multiplicity of individuals to generate, for non pre-cataloged items, structured, multi-language catalog entries in the crowd-sourced product catalog in a structured data format, and enabling any of a second multiplicity of individuals to employ any catalog entry existing in the crowd-sourced product catalog as a template for generating a modified catalog entry by modifying at least one parameter of the catalog entry.

Preferably, the method also includes automatically ranking the catalog entries in the crowd-sourced product catalog at least on the basis of their use by a third multiplicity of individuals, and making results of the ranking available for use by at least a fourth multiplicity of individuals. Preferably, the method also includes automatically establishing user-searchable unique codes for each of the catalog entries and enabling use of the user-searchable unique codes by multiple individuals for at least one of listing the corresponding product for sale, buying the corresponding product, obtaining information pertaining to the corresponding product and requesting updates pertaining to the corresponding product.

Preferably, the method also includes enabling a multiplicity of individuals to employ the catalog entries for listing products for sale, automatically ascertaining at least one of established prices, preferred buyers and preferred internet marketplaces for the products and automatically recommending to the multiplicity of individuals at least one of the established prices, preferred buyers and the preferred marketplaces for listing the products for sale.

Preferably, the method also includes automatically ascertaining at least one of established prices and preferred internet marketplaces for the products for sale and automatically listing the products for sale at at least one of the ascertained prices, to at least one of the preferred buyers and in at least one of the preferred marketplaces. Preferably, the method also includes enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, automatically ascertaining at least one of established prices and preferred internet marketplaces for each product, and automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplaces and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

There is also provided in accordance with another preferred embodiment of the present invention a system for generating a crowd-sourced product catalog, the system including crowd-sourced product catalog entry generating functionality operable for enabling any of a first multiplicity of individuals to generate, for non pre-cataloged items, structured, multi-language catalog entries in the crowd-sourced product catalog in a structured data format and catalog entry recycling functionality operable for enabling any of a second multiplicity of individuals to employ any catalog entry existing in the crowd-sourced product catalog as a template for generating a modified catalog by modifying at least one parameter of the catalog entry.

Preferably, the system also includes computerized automatic ranking functionality operable for automatically ranking the catalog entries in the crowd-sourced product catalog at least on the basis of their use by a third multiplicity of individuals. Preferably, the system also includes computerized code generating functionality operable for automatically establishing user-searchable unique codes for each of the catalog entries corresponding to a product, the each user-searchable unique code being useful for at least one of listing the corresponding product for sale, buying the corresponding product, obtaining information pertaining to the corresponding product and requesting updates pertaining to the corresponding product.

Preferably, the system also includes computerized market price and marketplace ascertaining functionality operable for automatically ascertaining at least one of established prices and preferred internet marketplaces for products corresponding to the catalog entries, and computerized recommendation generating functionality operable for automatically recommending to any of a multiplicity of individuals at least one of the established prices and the preferred marketplaces for listing the products for sale.

Preferably, the system also includes computerized market price and marketplace ascertaining functionality operable for automatically ascertaining at least one of established prices, preferred buyers and preferred internet marketplaces for products corresponding to the catalog entries and computerized listing generating functionality operable for at least one of automatically listing the products for sale at at least one of the ascertained prices and in at least one of the preferred marketplaces.

Preferably, the system also includes catalog entry utilization functionality operable for enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces, and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces, and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels, and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

There is further provided in accordance with yet another preferred embodiment of the present invention a method for generating a ranked crowd-sourced product catalog, the method including enabling any of a first multiplicity of individuals to generate structured, multi-language catalog entries in the crowd-sourced product catalog by at least one of copying catalog entries pre-existing in the crowd-sourced product catalog, modifying pre-existing catalog entries in the crowd-sourced product catalog and creating new catalog entries in the crowd-sourced product catalog, and automatically ranking the catalog entries in the crowd-sourced product catalog at least on the basis of their use by a second multiplicity of individuals.

Preferably, the method also includes automatically establishing user-searchable unique codes for each of the catalog entries, and enabling use of the user-searchable unique codes by multiple individuals for at least one of listing the corresponding product for sale, buying the corresponding product, obtaining information pertaining to the corresponding product and requesting updates pertaining to the corresponding product.

Preferably, the method also includes enabling a multiplicity of individuals to employ the catalog entries for listing products for sale, automatically ascertaining at least one of established prices, preferred buyers and preferred internet marketplaces for such products, and automatically recommending to the multiple individuals at least one of prices, preferred buyers and preferred marketplaces for listing products for sale. Preferably, the method also includes automatically ascertaining at least one of established prices, preferred buyers and preferred internet marketplaces for the products for sale, and automatically listing the products for sale at at least one of the ascertained prices, to at least one of the preferred buyers, and in at least one of the preferred marketplaces.

Preferably, the method also includes enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, automatically ascertaining at least one of established prices and preferred internet marketplaces for each product, and automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces, and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplaces, and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels, and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand. Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with still another preferred embodiment of the present invention a system for generating a ranked crowd-sourced product catalog, the system including crowd-sourced product catalog entry generating functionality operable for enabling any of a first multiplicity of individuals to generate structured, multi-language catalog entries in the crowd-sourced product catalog by at least one of copying catalog entries pre-existing in the crowd-sourced product catalog, modifying pre-existing catalog entries in the crowd-sourced product catalog and creating new catalog entries in the crowd-sourced product catalog, and computerized automatic ranking functionality operable for automatically ranking the catalog entries in the crowd-sourced product catalog at least on the basis of their use by a second multiplicity of individuals.

Preferably, the system also includes computerized code generating functionality operable for automatically establishing user-searchable unique codes for each of the catalog entries. Preferably, the system also includes computerized market price and marketplace ascertaining functionality operable for automatically ascertaining at least one of established prices, preferred buyers and preferred internet marketplaces for products corresponding to the catalog entries, and computerized recommendation generating functionality operable for automatically recommending to any of a multiplicity of individuals at least one of the established prices, the preferred buyers and the preferred marketplaces for listing the products for sale.

Preferably, the system also includes computerized market price and marketplace ascertaining functionality operable for automatically ascertaining at least one of established prices, preferred buyers and preferred internet marketplaces for products corresponding to the catalog entries, and computerized listing generating functionality operable for at least one of automatically listing the products for sale at at least one of the ascertained prices and in at least one of the preferred marketplaces.

Preferably, the system also includes catalog entry utilization functionality operable for enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces, and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces, and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels, and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates.

There is also provided in accordance with another preferred embodiment of the present invention a method for generating a coded crowd-sourced product catalog, the method including enabling multiple individuals to generate structured, multi-language catalog entries in the crowd-sourced product catalog, each of the catalog entries corresponding to a product, automatically establishing user-searchable unique codes for each of the catalog entries, and enabling use of the user-searchable unique codes by multiple individuals for at least one of listing the corresponding product for sale, buying the corresponding product, obtaining information pertaining to the corresponding product and requesting updates pertaining to the corresponding product.

Preferably, the method also includes enabling a multiplicity of individuals to employ the catalog entries for listing products for sale, automatically ascertaining at least one of established prices, preferred buyers and preferred internet marketplaces for the products and automatically recommending to the multiplicity of individuals at least one of the established prices, preferred buyers and the preferred marketplaces for listing the products for sale.

Preferably, the method also includes automatically ascertaining at least one of established prices and preferred internet marketplaces for the products for sale, and automatically listing the products for sale at at least one of the ascertained prices, to at least one of the preferred buyers and in at least one of the preferred marketplaces. Preferably, the method also includes enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, automatically ascertaining at least one of established prices and preferred internet marketplaces for each product, and automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces, and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplace, and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand. Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates.

There is further provided in accordance with yet another preferred embodiment of the present invention a system for generating a coded crowd-sourced product catalog, the system including crowd-sourced product catalog entry generating functionality operable for enabling multiple individuals to generate structured, multi-language catalog entries in the crowd-sourced product catalog, each of the catalog entries corresponding to a product, and computerized code generating functionality operable for automatically establishing user-searchable unique codes for each of the catalog entries corresponding to a product, the each user-searchable unique code being useful for at least one of listing the corresponding product for sale, buying the corresponding product, obtaining information pertaining to the corresponding product and requesting updates pertaining to the corresponding product.

Preferably, the system also includes computerized market price and marketplace ascertaining functionality operable for automatically ascertaining at least one of established prices and preferred internet marketplaces for products corresponding to the catalog entries, and computerized recommendation generating functionality operable for automatically recommending to any of a multiplicity of individuals at least one of the established prices and the preferred marketplaces for listing the products for sale. Preferably, the system also includes computerized market price and marketplace ascertaining functionality operable for automatically ascertaining at least one of established prices, preferred buyers and preferred internet marketplaces for products corresponding to the catalog entries, and computerized listing generating functionality operable for at least one of automatically listing the products for sale at at least one of the ascertained prices and in at least one of the preferred marketplaces.

Preferably, the system also includes catalog entry utilization functionality operable for enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces, and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces, and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels, and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of the following new listings of products for sale, new catalog entries, requests to buy products, requests for product information, collectors' catalogs, sub-catalogs forming part of a larger catalog, information contributions, requests to receive product demand updates, and product availability updates. Alternatively, the catalog entries, each of the catalog entries corresponding to a product, are configured to be employed for generating at least two of the following new listings of products for sale, new catalog entries, requests to buy products, requests for product information, collectors' catalogs, sub-catalogs forming part of a larger catalog, information contributions, requests to receive product demand updates, and product availability updates.

There is also provided in accordance with yet another preferred embodiment of the present invention a method for employing a crowd-sourced catalog for listing products for sale, the method including enabling multiple individuals to generate structured, multi-language catalog entries in the crowd-sourced product catalog, each of the catalog entries corresponding to a product, automatically ascertaining at least one of established prices and preferred internet marketplaces for the products and automatically recommending to any of a multiplicity of individuals at least one of the established prices and the preferred marketplaces for listing the products for sale.

Preferably, the method also includes enabling a multiplicity of individuals to employ the catalog entries for listing products for sale, automatically ascertaining at least one of established prices and preferred internet marketplaces for the products for sale and automatically listing the products for sale at at least one of the ascertained prices, to at least one of the preferred buyers and in at least one of the preferred marketplaces.

Preferably, the method also includes enabling a multiplicity of individuals to employ the catalog entries for listing products for sale, automatically ascertaining at least one of established prices, preferred buyers and preferred internet marketplaces for the products and automatically recommending to the multiplicity of individuals at least one of the established prices, preferred buyers and the preferred marketplaces for listing the products for sale. Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplaces and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates.

There is also provided in accordance with yet another preferred embodiment of the present invention a system for employing a crowd-sourced catalog for listing products for sale, the system including crowd-sourced product catalog entry generating functionality operable for enabling multiple individuals to generate structured, multi-language catalog entries in the crowd-sourced product catalog, each of the catalog entries corresponding to a product, computerized market price and marketplace ascertaining functionality operable for automatically ascertaining at least one of established prices and preferred internet marketplaces for the products, and computerized recommendation generating functionality operable for automatically recommending to any of a multiplicity of individuals at least one of the established prices and the preferred marketplaces for listing the products for sale.

Preferably, the system also includes computerized market price and marketplace ascertaining functionality operable for automatically ascertaining at least one of established prices, preferred buyers and preferred internet marketplaces for products corresponding to the catalog entries and computerized listing generating functionality operable for at least one of automatically listing the products for sale at at least one of the ascertained prices and in at least one of the preferred marketplaces.

Preferably, the system also includes catalog entry utilization functionality operable for enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces, and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces, and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels, and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates.

There is also provided in accordance with yet another preferred embodiment of the present invention a method for employing a crowd-sourced catalog for listing products for sale, the method including enabling multiple individuals to generate structured, multi-language catalog entries in the crowd-sourced product catalog, each of the catalog entries corresponding to a product, automatically ascertaining at least one of established prices and preferred internet marketplaces for the products for sale and automatically listing the products for sale at at least one of the ascertained prices and in at least one of the preferred marketplaces.

Preferably, the method also includes enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, automatically ascertaining at least one of established prices and preferred internet marketplaces for each product, and automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces; and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplaces and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a system for employing a crowd-sourced catalog for listing products for sale, the system including crowd-sourced product catalog entry generating functionality operable for enabling multiple individuals to generate structured, multi-language catalog entries in the crowd-sourced product catalog, each of the catalog entries corresponding to a product, computerized market price and marketplace ascertaining functionality operable for automatically ascertaining at least one of established prices and preferred internet marketplaces for the products for sale, and computerized listing generating functionality operable for automatically listing the products for sale at at least one of the ascertained prices and in at least one of the preferred marketplaces.

Preferably, the system also includes catalog entry utilization functionality operable for enabling any of a multiplicity of individuals to employ any catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels, and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a method for automatically employing a crowd-sourced product catalog, the method including enabling any of a multiplicity of individuals to employ any structured, multi-language catalog entry of the crowd-sourced product catalog corresponding to a product, for at least one of buying the product,

finding the product, receiving demand alerts pertaining to the product and receiving product availability alerts spanning multiple marketplaces, automatically ascertaining at least one of established prices and preferred internet marketplaces for each product, and automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces and automatically effecting a purchase transaction when a product availability alert indicates the availability of a product having a price which does not exceed a previously ascertained acceptable price for the product.

Preferably, the preferred marketplace is ascertained on the basis of availability of particular ones of the products.

Preferably, the method also includes enabling any of a multiplicity of individuals to request and receive product demand alerts pertaining to any of a multiplicity of products corresponding to the catalog entries and spanning multiple computerized marketplaces, automatically ascertaining at least one of a preferred buyer and an acceptable price for the products across the multiple computerized marketplaces, and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a system for automatically employing a crowd-sourced product catalog, the system including catalog entry utilization functionality operable for enabling any of a multiplicity of individuals to employ any structured, multi-language catalog entry of the crowd-sourced product catalog corresponding to a product, for at least one of buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product and computerized recommendation generating functionality operable for automatically recommending to any of the multiplicity of individuals at least one of the established prices and preferred marketplaces for at least one of buying the product, finding the product, receiving demand alerts pertaining to the product and receiving demand alerts pertaining to the product, the recommendations spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces, and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the preferred marketplace is ascertained on the basis of availability of particular ones of the products.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a method for automatically employing a crowd-sourced product, the method including enabling any of a multiplicity of individuals to employ any structured, multi-language catalog entry of the crowd-sourced product catalog for at least one of buying the product, finding the product, receiving demand alerts pertaining to the product and receiving product availability alerts spanning multiple marketplaces, automatically ascertaining at least one of established prices and preferred internet marketplaces for each product, and automatically selecting at least one of a price and at least one preferred marketplace for at least one of buying the product, finding the product receiving demand alerts pertaining to the product and receiving demand alerts pertaining to the product, the selections spanning the multiple marketplaces.

Preferably, the method also includes enabling any of a multiplicity of individuals to request and to receive product availability alerts pertaining to any a multiplicity of products corresponding to the catalog entries and spanning multiple computerized marketplaces, automatically ascertaining acceptable prices for the products across the multiple computerized marketplaces and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplaces automatically ascertaining at least one of a preferred buyer and an acceptable price for the products across the multiple computerized marketplaces, and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a system for automatically employing a crowd-sourced product catalog, the system including catalog entry utilization functionality operable for enabling any of a multiplicity of individuals to employ any structured, multi-language catalog entry of the crowd-sourced product catalog for at least one of

buying the product, finding the product, receiving demand alerts pertaining to the product and receiving product availability alerts spanning multiple marketplaces, computerized price/marketplace ascertaining functionality operable for automatically ascertaining at least one of established prices and preferred internet marketplaces for each product, and computerized selection functionality operable for automatically selecting at least one of a price and at least one preferred marketplace for at least one of buying the product, finding the product, receiving demand alerts pertaining to the product and receiving demand alerts pertaining to the product, the selections spanning the multiple marketplaces.

Preferably, the system also includes product availability alert generating functionality operable for enabling any of a multiplicity of individuals to request and to receive product availability alerts pertaining to any a multiplicity of products corresponding to the catalog entries and spanning multiple computerized marketplaces, computerized price ascertaining functionality operable for automatically ascertaining acceptable prices for the products across the multiple computerized marketplaces and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a method for automated computerized commerce spanning multiple computerized marketplaces, the method including enabling any of a multiplicity of individuals to request and to receive product availability alerts pertaining to any a multiplicity of products corresponding to a multiplicity of structured, multi-language catalog entries and spanning multiple computerized marketplaces, automatically ascertaining acceptable prices for the products across the multiple computerized marketplaces and automatically effecting a purchase transaction when a product availability alert indicates the availability of a product having a price which does not exceed a previously ascertained acceptable price for the product.

Preferably, the method also includes enabling any of a multiplicity of individuals to request and receive product demand alerts pertaining to any of a multiplicity of products corresponding to the catalog entries and spanning multiple computerized marketplace, automatically ascertaining at least one of a preferred buyer and an acceptable price for the products across the multiple computerized marketplaces, and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the preferred marketplace is ascertained on the basis of availability of particular ones of the products.

Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a system for automated computerized commerce spanning multiple computerized marketplaces, the system including product availability alert generating functionality operable for enabling any of a multiplicity of individuals to request and to receive product availability alerts pertaining to any a multiplicity of products corresponding to a multiplicity of structured, multi-language catalog entries and spanning multiple computerized marketplaces, computerized price ascertaining functionality operable for automatically ascertaining acceptable prices for the products across the multiple computerized marketplaces and computerized purchasing functionality operable for automatically effecting a purchase transaction for at least one of the products when a product availability alert indicates an availability of the product for purchase at a price which does not exceed a previously ascertained acceptable price for the product.

Preferably, the system also includes product demand alert generating functionality operable for enabling any of a multiplicity of individuals to request and receive product demand alerts pertaining to any of a multiplicity of products corresponding to the catalog entries and spanning multiple computerized marketplaces, computerized price/preferred buyer ascertaining functionality operable for automatically ascertaining at least one of a preferred buyer and an acceptable price for the products across the multiple computerized marketplaces and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the preferred marketplace is ascertained on the basis of availability of particular ones of the products.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels and computerized product demand alert utilization functionality operable for enabling any of the multiplicity of individuals to respond to the product demand alerts via at least one of the multiplicity of computerized marketplaces and communications channels.

Preferably, enabling at least one of the multiple independent individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a method for automated computerized commerce spanning multiple computerized marketplaces, the method including enabling any of a multiplicity of individuals to request and receive product demand alerts pertaining to any of a multiplicity of products corresponding to a multiplicity of structured, multi-language catalog entries and spanning multiple computerized marketplaces automatically ascertaining at least one of a preferred buyer and an acceptable price for the products across the multiple computerized marketplaces and automatically effecting a purchase transaction for at least one of the products when either a product demand alert indicates demand for the product at a price which is not less than a previously ascertained acceptable price for the product or a buyer of the product meeting pre-defined criteria is identified.

Preferably, the method also includes ascertaining a preferred marketplace on the basis of availability of particular ones of the products. Preferably, the method also includes enabling any of a multiplicity of individuals to request and receive product demand alerts pertaining to any of a multiplicity of products corresponding to the catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least six of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a system for automated computerized commerce spanning multiple computerized marketplaces, the system including product demand alert generating functionality operable for enabling any of a multiplicity of individuals to request and receive product demand alerts pertaining to any of a multiplicity of products corresponding to a multiplicity of structured, multi-language catalog entries and spanning multiple computerized marketplaces, computerized price/preferred buyer ascertaining functionality operable for automatically ascertaining at least one of a preferred buyer and an acceptable price for the products across the multiple computerized marketplaces, and computerized purchasing functionality operable for automatically effecting a purchase transaction for at least one of the products when either a product demand alert indicates demand for the product at a price which is not less than a previously ascertained acceptable price for the product or a preferred buyer of the product meeting pre-defined criteria is identified.

Preferably, the computerized price/preferred buyer ascertaining functionality is operable for ascertaining a preferred marketplace on the basis of availability of particular ones of the products.

Preferably, the system also includes computerized product demand alert generating functionality operable for enabling any of a multiplicity of individuals to request and receive product demand alerts pertaining to any of a multiplicity of products corresponding to the catalog entries, computerized product demand alert disseminator functionality operable for disseminating the product demand alerts via at least one of a multiplicity of computerized marketplaces and communications channels and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

Preferably, the catalog entries, each of the catalog entries corresponding to a product, are configured to be employed for generating at least one of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least two of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least three of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least four of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least five of new listings of products for sale, new catalog entries, requests to buy products, requests for product information, collectors' catalogs, sub-catalogs forming part of a larger catalog, information contributions, requests to receive product demand updates and product availability updates. Alternatively, the catalog entries, each of the catalog entries corresponding to a product, are configured to be employed for generating at least six of new listings of products for sale, new catalog entries, requests to buy products, requests for product information, collectors' catalogs, sub-catalogs forming part of a larger catalog, information contributions, requests to receive product demand updates and product availability updates.

There is yet further provided in accordance with yet another preferred embodiment of the present invention a computerized method for commerce including enabling any of a multiplicity of individuals to request and receive product demand alerts pertaining to any of a multiplicity of products corresponding to a multiplicity of structured, multi-language catalog entries, disseminating the product demand alerts via at least one of a multiplicity of computerized marketplaces and communications channels and enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

There is yet further provided in accordance with yet another preferred embodiment of the present invention a computerized system for commerce including computerized product demand alert generating functionality operable for enabling any of a multiplicity of individuals to request and receive product demand alerts pertaining to any of a multiplicity of products corresponding to a multiplicity of structured, multi-language catalog entries, computerized product demand alert disseminator functionality operable for disseminating the product demand alerts via at least one of a multiplicity of computerized marketplaces and communications channels and computerized product demand alert utilization functionality operable for enabling any of the multiplicity of individuals to respond to the product demand alerts via at least one of the multiplicity of computerized marketplaces and communications channels.

Preferably, enabling any of the multiplicity of individuals to respond to the product demand alerts includes at least one of listing a product in demand for sale, generating a catalog of products in demand and effecting a sale of a product in demand.

### BRIEF DESCRIPTION OF THE DRAWINGS

The present invention will be understood and appreciated more fully from the following detailed description, taken in conjunction with the drawings in which:

FIG. 1A is a simplified block diagram illustration of a system for generating a crowd-sourced product catalog, constructed and operative in accordance with a preferred embodiment of the present invention;

FIG. 1B is a simplified flowchart illustration of steps in the operation of the system of FIG. 1A;

FIG. 2A is a simplified block diagram illustration of a system for generating a crowd-sourced product catalog, constructed and operative in accordance with another preferred embodiment of the present invention;

FIG. 2B is a simplified flowchart illustration of steps in the operation of the system of FIG. 2A;

FIG. 3A is a simplified block diagram illustration of a system for generating a crowd-sourced product catalog, constructed and operative in accordance with yet another preferred embodiment of the present invention;

FIG. 3B is a simplified flowchart illustration of steps in the operation of the system of FIG. 3A;

FIG. 4A is a simplified block diagram illustration of a system for employing a crowd-sourced catalog for listing products for sale, constructed and operative in accordance with still another preferred embodiment of the present invention;

FIG. 4B is a simplified flowchart illustration of steps in the operation of the system of FIG. 4A;

FIG. 5A is a simplified block diagram illustration of a system for employing a crowd-sourced catalog for listing products for sale, constructed and operative in accordance with another preferred embodiment of the present invention;

FIG. 5B is a simplified flowchart illustration of steps in the operation of the system of FIG. 5A;

FIG. 6A is a simplified block diagram illustration of a system for automatically employing a crowd-sourced catalog, constructed and operative in accordance with yet another preferred embodiment of the present invention;

FIG. 6B is a simplified flowchart illustration of steps in the operation of the system of FIG. 6A;

FIG. 7A is a simplified block diagram illustration of a system for automatically employing a crowd-sourced catalog, constructed and operative in accordance with yet another preferred embodiment of the present invention;

FIG. 7B is a simplified flowchart illustration of steps in the operation of the system of FIG. 7A;

FIG. 8A is a simplified block diagram illustration of a system for automated computerized commerce, constructed and operative in accordance with yet another preferred embodiment of the present invention;

FIG. 8B is a simplified flowchart illustration of steps in the operation of the system of FIG. 8A;

FIG. 9A is a simplified block diagram illustration of a system for automated computerized commerce, constructed and operative in accordance with yet another preferred embodiment of the present invention;

FIG. 9B is a simplified flowchart illustration of steps in the operation of the system of FIG. 9A;

FIG. 10A is a simplified block diagram illustration of a system for computerized commerce, constructed and operative in accordance with yet another preferred embodiment of the present invention; and

FIG. 10B is a simplified flowchart illustration of steps in the operation of the system of FIG. 10A.

### DETAILED DESCRIPTION OF PREFERRED EMBODIMENTS

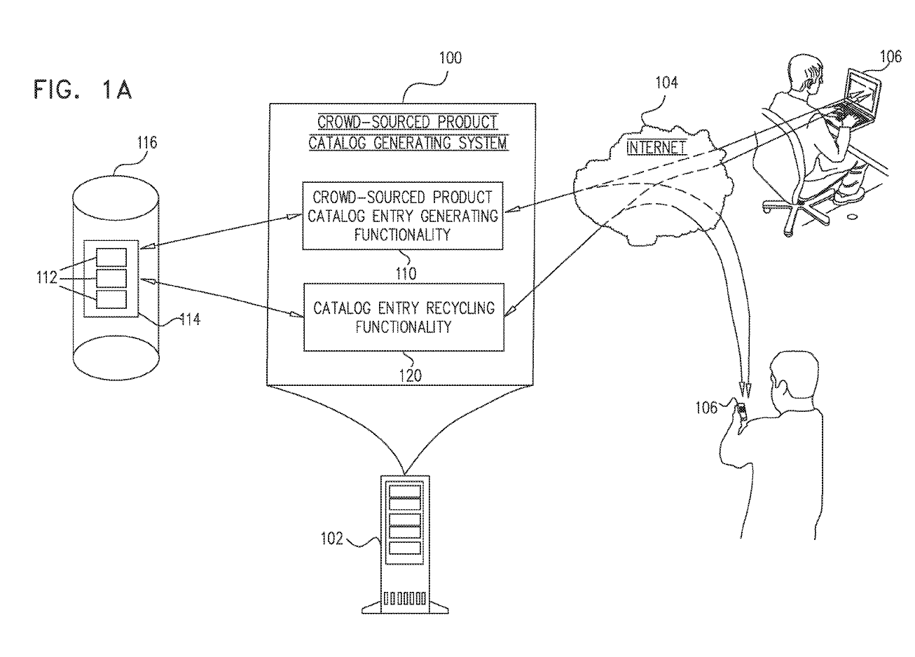

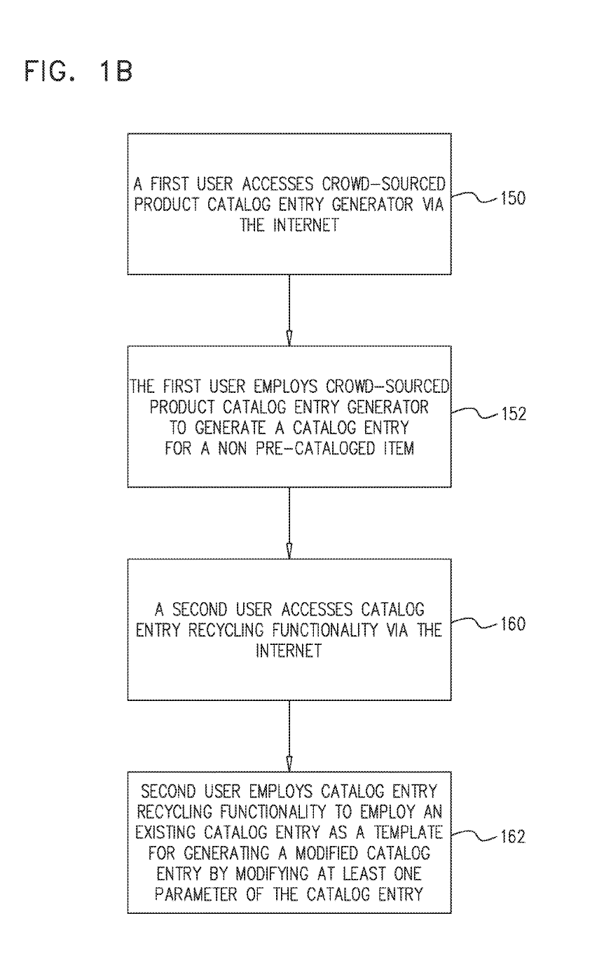

Reference is now made to FIG. 1A, which is a simplified block diagram illustration of a system for generating a crowd-sourced product catalog, constructed and operative in accordance with a preferred embodiment of the present invention, and to FIG. 1B, which is a simplified flowchart illustration of steps in the operation of the system of FIG. 1A. For the purposes of the present application, the term “crowd-sourced product catalog” is defined to include, inter alia, an on-line product catalog preferably mutually generated by a multiplicity of users. Each catalog entry of the crowd-sourced product catalog preferably includes information pertaining to the sale of a particular product such as, for example, a specification of the product, sellers of the particular product, buyers of the particular product, marketplaces for the particular product and product availability and demand.

The system 100 of FIG. 1A preferably resides on a suitable computing device, such as a computer server 102 connected to the internet 104. Users of system 100 typically access system 100 via the internet by employing an internet-enabled computing device 106 such as a desktop or laptop computer, or a mobile communicator device. Users of system 100 typically include, for example, product sellers listing items for sale, product buyers, internet marketplace operators, product collectors, information contributors, requesters of product information, requesters of updates pertaining to product demand and requesters of updates pertaining to product availability.

System 100 preferably includes crowd-sourced product catalog entry generating functionality 110 operable for enabling users of system 100 to generate, for non pre-cataloged items, catalog entries 112 in a crowd-sourced product catalog 114 in a structured multi-language data format. It is appreciated that the structured multi-language format of catalog entries 112 is instrumental in allowing users of system 100 to generate catalog entries 112 in any of a multiplicity of languages and to allow other users of system 100 to view catalog entries 112 in any of a multiplicity of languages, thereby facilitating international, multi-language e-commerce.

Crowd-sourced product catalog 114 is preferably stored in a product catalog database 116 accessible to system 100. Catalog entries 112 may be employed, for example, for listing a product for sale, for requesting to purchase a product described therein, for requesting information pertaining to the described therein, for generating a collectors' catalog, for generating a sub-catalog forming a part of a larger product catalog which catalog may not be crowd-sourced, for requesting updates pertaining to demand for the product described therein and for requesting updates pertaining to product availability of the product described therein.

Crowd-sourced product catalog generating functionality 110 typically provides a structured data format for preparing catalog entries for non pre-cataloged items, such as used items for which catalog entries typically do not pre-exist in crowd-sourced product catalog 114. A preferred system for generating catalog entries for non pre-cataloged items is described in U.S. Patent Publication No. 2012/0109786. Alternatively, any suitable system for generating catalog entries may be used.

System 100 also preferably includes catalog entry recycling functionality 120 operable for enabling users of system 100 to employ any catalog entry 112 existing in crowd-sourced product catalog 114 as a template for generating a new or modified catalog entry by any of adding, deleting or modifying at least one parameter of the catalog entry or a value thereof. The new or modified catalog entry may be employed, for example, for generating a new product listing for sale, a new catalog entry in crowd-sourced product catalog 114, a purchase request for a product, a product information request, a collectors' catalog, a sub-catalog forming a part of a larger product catalog which catalog may not be crowd-sourced, a request for updates pertaining to product demand and a request for updates pertaining to product availability. It is appreciated that catalog entry recycling functionality 120 may be employed to simultaneously generate a multiplicity of new or modified catalog entries by any of simultaneously adding, deleting or modifying at least one parameter of a multiplicity of catalog entries.

It is appreciated that product catalog generating functionality 110 and catalog entry recycling functionality 120 may both be employed by identical users. Alternatively, at least some of the users employing catalog entry recycling functionality 120 may be users other than the users employing product catalog generating functionality 110.

Turning to FIG. 1B, it is shown that a first individual wishing to generate a catalog entry in the crowd-sourced product catalog typically initially accesses crowd-sourced product catalog entry generator 110 of FIG. 1A via the internet (150) and employs crowd-sourced product catalog entry generator 110 to generate a catalog entry for a non pre-cataloged item (152).

As further shown in FIG. 1B, subsequent to the generation of the catalog entry in the crowd-sourced product catalog, a second individual preferably accesses catalog entry recycling functionality 120 of FIG. 1B via the internet (160) and employs catalog entry recycling functionality 120 to employ a catalog entry existing in the crowd-sourced product catalog as a template for generating a modified catalog entry by modifying at least one parameter of the catalog entry (162).

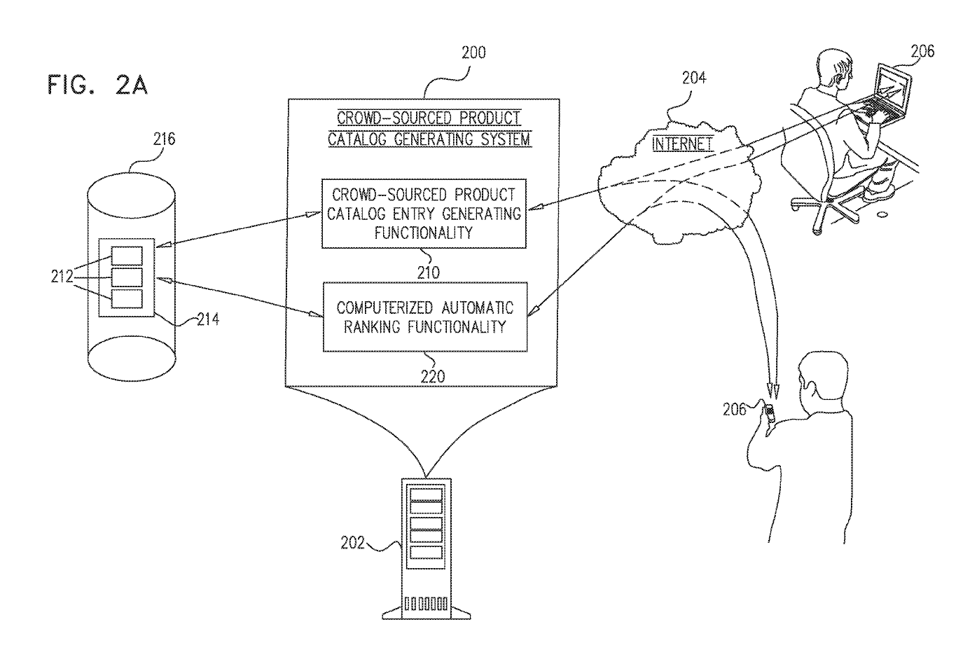

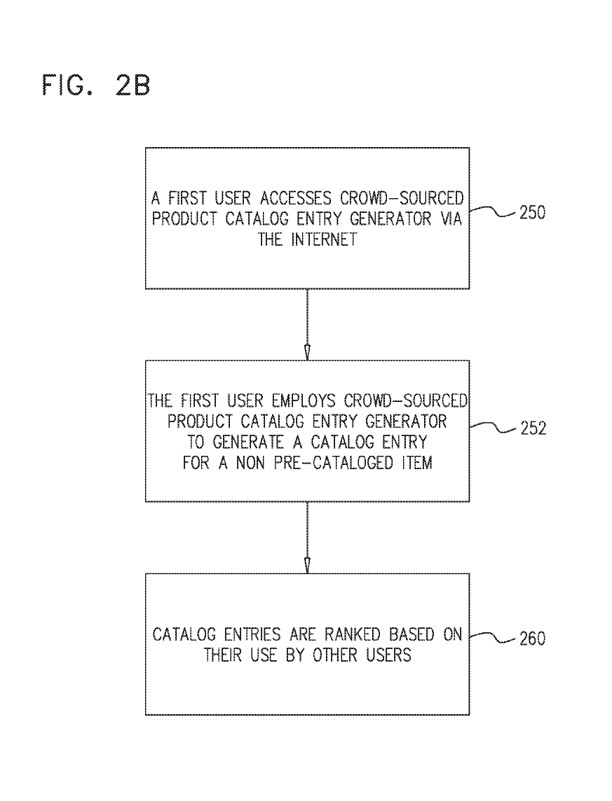

Reference is now made to FIG. 2A, which is a simplified block diagram illustration of a system for generating a crowd-sourced product catalog, constructed and operative in accordance with another preferred embodiment of the present invention, and to FIG. 2B which is a simplified flowchart illustration of steps in the operation of the system of FIG. 2A.

The system 200 of FIG. 2A preferably resides on a suitable computing device, such as a computer server 202 connected to the internet 204. Users of system 200 typically access system 200 via the internet by employing an internet-enabled computing device 206 such as a desktop or laptop computer, or a mobile communicator device. Users of system 200 typically include, for example, product sellers listing items for sale, product buyers, internet marketplace operators, product collectors, information contributors, requesters of product information, requesters of updates pertaining to product demand and requesters of updates pertaining to product availability.

System 200 preferably includes crowd-sourced product catalog entry generating functionality 210 operable for enabling users of system 200 to generate structured, multi-language catalog entries 212 in a crowd-sourced product catalog 214 by at least one of copying catalog entries existing in crowd-sourced product catalog 214, modifying existing catalog entries in crowd-sourced product catalog 214 and generating new catalog entries in crowd-sourced product catalog 214. Crowd-sourced product catalog 214 is preferably stored in a product catalog database 216 accessible to system 200.

Catalog entries 212 may be employed, for example, for listing a product for sale, for requesting to purchase a product described therein, for requesting information pertaining to the described therein, for generating a collectors' catalog, for generating a sub-catalog forming a part of a larger product catalog which catalog may not be crowd-sourced, for requesting updates pertaining to demand for the product described therein and for requesting updates pertaining to product availability of the product described therein.

Crowd-sourced product catalog generating functionality 210 typically provides a structured multi-language data format for preparing catalog entries for non pre-cataloged items, such as used items for which catalog entries typically do not pre-exist in crowd-sourced product catalog 214. A preferred system for generating catalog entries for non pre-cataloged items is described in U.S. Patent Publication No. 2012/0109786. Alternatively, any suitable system for generating catalog entries may be used.

System 200 also preferably includes computerized automatic ranking functionality 220 operable for automatically ranking catalog entries 212 in crowd-sourced product catalog 214 at least on the basis of their use by users other than the users who have generated catalog entries 212. Typically, the automated ranking is based on, for example, at least one of the extent of use, modification, addition, deletion and correction of catalog entry 212 as noted by any of the other users.

It is appreciated that ranking information generated by computerized automatic ranking functionality 220 is preferably available to users of system 200 in any of a multiplicity of formats such as, for example, by order of presentation as displayed using color coded or number coded schemas.

Turning to FIG. 2B, it is shown that an individual wishing to generate a catalog entry in the crowd-sourced product catalog typically initially accesses crowd-sourced product catalog entry generating functionality 210 of FIG. 2A via the internet (250) and employs crowd-sourced product catalog entry generating functionality 210 to generate a catalog entry for a non pre-cataloged item (252).

As further shown in FIG. 2B, subsequent to the generation of the catalog entries in the crowd-sourced product catalog, the catalog entries in the crowd-sourced product catalog are automatically ranked at least on the basis of their use by other individuals (260).

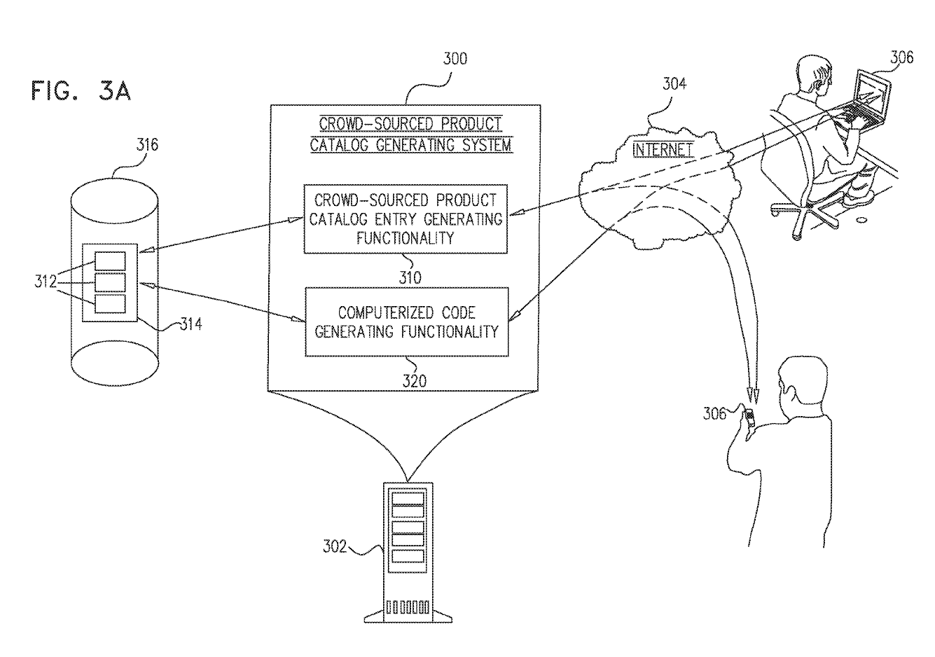

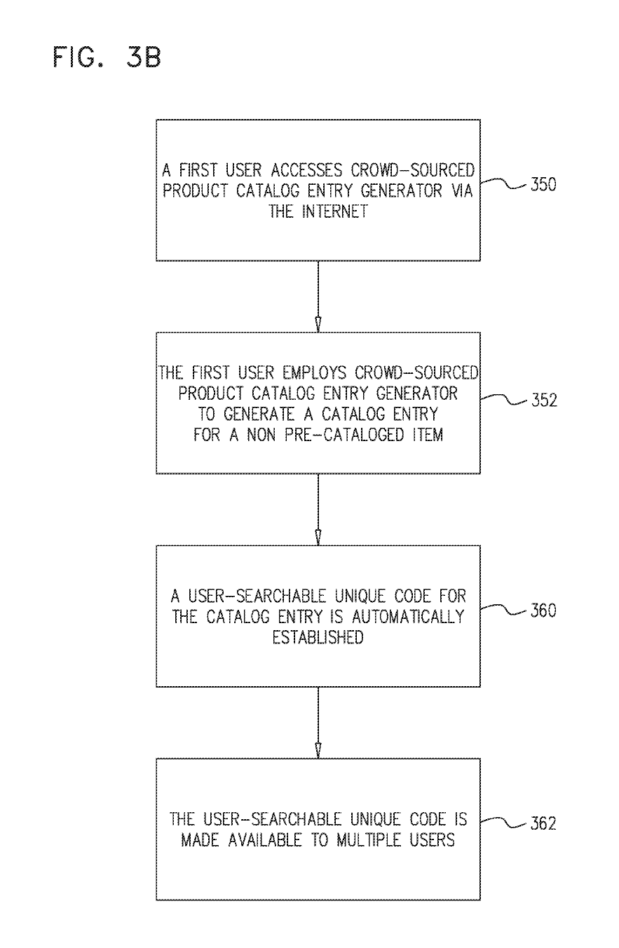

Reference is now made to FIG. 3A, which is a simplified block diagram illustration of a system for generating a crowd-sourced product catalog, constructed and operative in accordance with yet another preferred embodiment of the present invention, and to FIG. 3B, which is a simplified flowchart illustration of steps in the operation of the system of FIG. 3A.

The system 300 of FIG. 3A preferably resides on a suitable computing device, such as a computer server 302 connected to the internet 304. Users of system 300 typically access system 300 via the internet by employing an internet-enabled computing device 306 such as a desktop or laptop computer, or a mobile communicator device. Users of system 300 typically include, for example, product sellers listing items for sale, product buyers, internet marketplace operators, product collectors, information contributors, requesters of product information, requesters of updates pertaining to product demand and requesters of updates pertaining to product availability.

System 300 preferably includes crowd-sourced product catalog entry generating functionality 310 operable for enabling users of system 300 to generate, for non pre-cataloged items, structured, multi-language catalog entries 312 in a crowd-sourced product catalog 314, each of catalog entries 312 corresponding to a product. Crowd-sourced product catalog 314 is preferably stored in a product catalog database 316 accessible to system 300. Catalog entries 312 may be employed, for example, for listing a product for sale, for requesting to purchase a product described therein, for requesting information pertaining to the described therein, for generating a collectors' catalog, for generating a sub-catalog forming a part of a larger product catalog which catalog may not be crowd-sourced, for requesting updates pertaining to demand for the product described therein and for requesting updates pertaining to product availability of the product described therein.

Crowd-sourced product catalog generating functionality 310 typically provides a structured data format for preparing catalog entries for non pre-cataloged items, such as used items for which catalog entries typically do not pre-exist in crowd-sourced product catalog 314. A preferred system for generating catalog entries for non pre-cataloged items is described in U.S. Patent Publication No. 2012/0109786. Alternatively, any suitable system for generating catalog entries may be used.

System 300 also preferably includes computerized code generating functionality 320 operable for automatically establishing user-searchable unique codes for each of catalog entries 312 corresponding to a product, the user-searchable unique codes being useful for at least one of listing the corresponding product for sale, buying the corresponding product, obtaining information pertaining to the corresponding product and requesting updates pertaining to the corresponding product.

Turning to FIG. 3B, it is shown that a first individual wishing to generate a catalog entry in the crowd-sourced product catalog typically initially accesses crowd-sourced product catalog entry generator 310 of FIG. 3A via the internet (350) and employs crowd-sourced product catalog entry generator 310 to generate a catalog entry for a non pre-cataloged item (352), which catalog entry corresponds to a product.

As further shown in FIG. 3B, subsequent to the generation of the catalog entry in the crowd-sourced product catalog, a user-searchable unique code for the catalog entry is automatically established (360), and the user-searchable unique code is made available to multiple individuals (362) for at least one of listing the corresponding product for sale, buying the corresponding product, obtaining information pertaining to the corresponding product and requesting updates pertaining to the corresponding product.

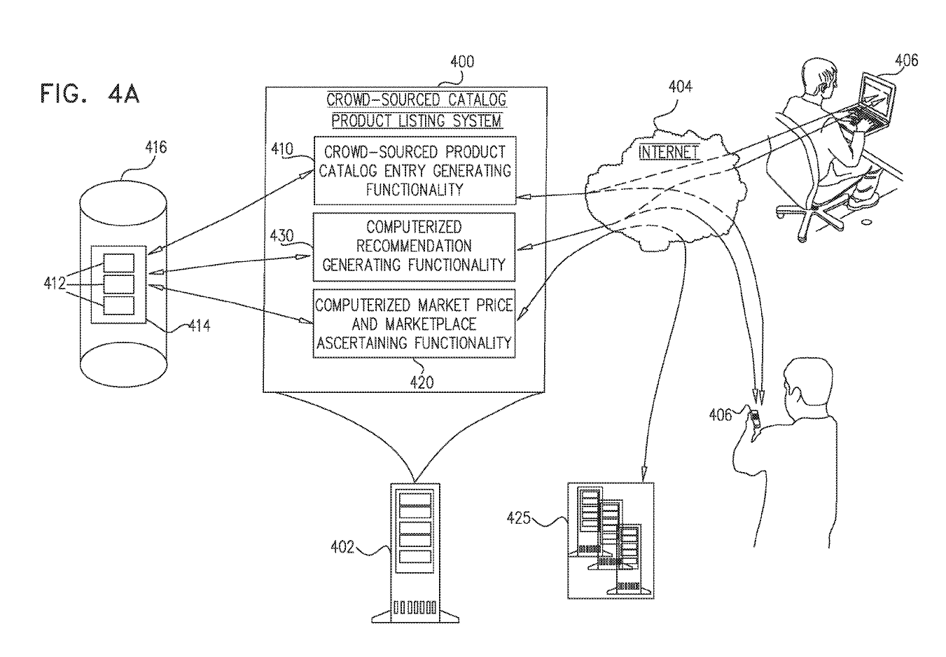

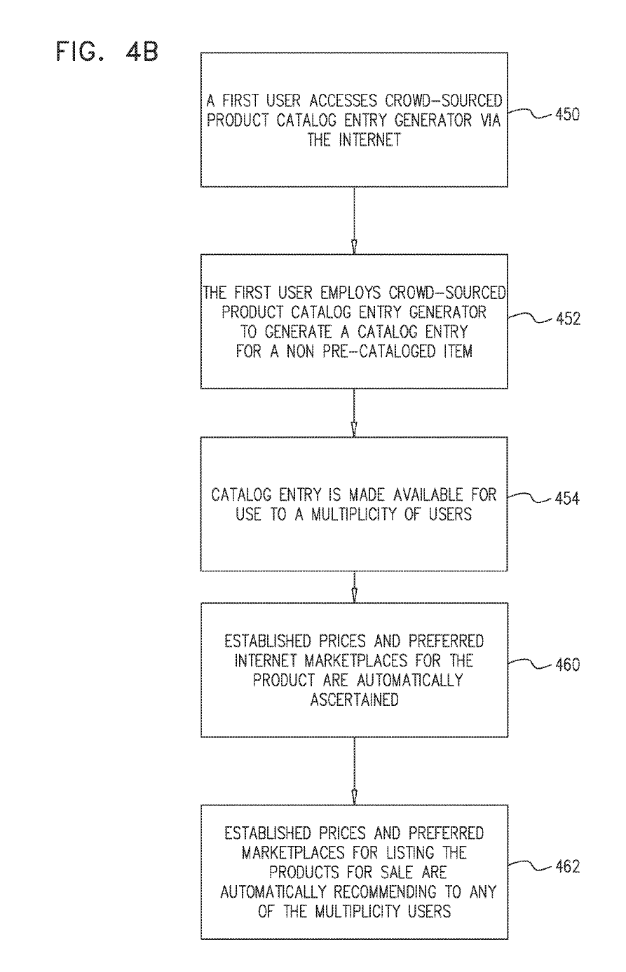

Reference is now made to FIG. 4A, which is a simplified block diagram illustration of a system for employing a crowd-sourced catalog for listing products for sale, constructed and operative in accordance with still another preferred embodiment of the present invention, and to FIG. 4B, which is a simplified flowchart illustration of steps in the operation of the system of FIG. 4A.

The system 400 of FIG. 4A preferably resides on a suitable computing device, such as a computer server 402 connected to the internet 404. Users of system 400 typically access system 400 via the internet by employing an internet-enabled computing device 406 such as a desktop or laptop computer, or a mobile communicator device. Users of system 400 typically include, for example, product sellers listing items for sale, product buyers, internet marketplace operators, product collectors, information contributors, requesters of product information, requesters of updates pertaining to product demand and requesters of updates pertaining to product availability.

System 400 preferably includes crowd-sourced product catalog entry generating functionality 410 operable for enabling users of system 400 to generate structured, multi-language catalog entries 412 in a crowd-sourced product catalog 414, each of catalog entries 412 corresponding to a product. Crowd-sourced product catalog 414 is preferably stored in a product catalog database 416 accessible to system 400. Catalog entries 412 may be employed, for example, for listing a product for sale, for requesting to purchase a product described therein, for requesting information pertaining to the described therein, for generating a collectors' catalog, for generating a sub-catalog forming a part of a larger product catalog which catalog may not be crowd-sourced, for requesting updates pertaining to demand for the product described therein and for requesting updates pertaining to product availability of the product described therein.

Crowd-sourced product catalog generating functionality 410 typically provides a structured data format for preparing catalog entries for non pre-cataloged items, such as used items for which catalog entries typically do not pre-exist in crowd-sourced product catalog 414. A preferred system for generating catalog entries for non pre-cataloged items is described in U.S. Patent Publication No. 2012/0109786. Alternatively, any suitable system for generating catalog entries may be used.

System 400 also preferably includes computerized market price and marketplace ascertaining functionality 420 operable for automatically ascertaining at least one of established prices and preferred internet marketplaces 425 for the products described in catalog entries 412. System 400 preferably further includes computerized recommendation generating functionality 430 operable for automatically recommending to any of a multiplicity of individuals at least one of the established prices and the preferred marketplaces for listing the products described in catalog entries 412 for sale. It is appreciated that the recommendations may be employed by any of the multiplicity of individuals for generating a new product listing for sale, a new catalog entry in crowd-sourced product catalog 414, a purchase request for a product, a product information request, a collectors' catalog, a sub-catalog forming a part of a larger product catalog which catalog may not be crowd-sourced, a request for updates pertaining to product demand and a request for updates pertaining to product availability.

Turning to FIG. 4B, it is shown that a first individual wishing to generate a catalog entry in the crowd-sourced product catalog typically initially accesses crowd-sourced product catalog entry generator 410 of FIG. 4A via the internet (450) and employs crowd-sourced product catalog entry generator 410 to generate a catalog entry corresponding to a product (452).

As further shown in FIG. 4B, subsequent to the generation of the catalog entry in the crowd-sourced product catalog, the catalog entry is made available for use to a multiplicity of users (454), allowing for established prices and preferred internet marketplaces for the product to be automatically ascertained (460). Thereafter, at least one of the established prices and the preferred marketplaces for listing the products for sale are automatically recommending to any of a multiplicity of individuals (462).

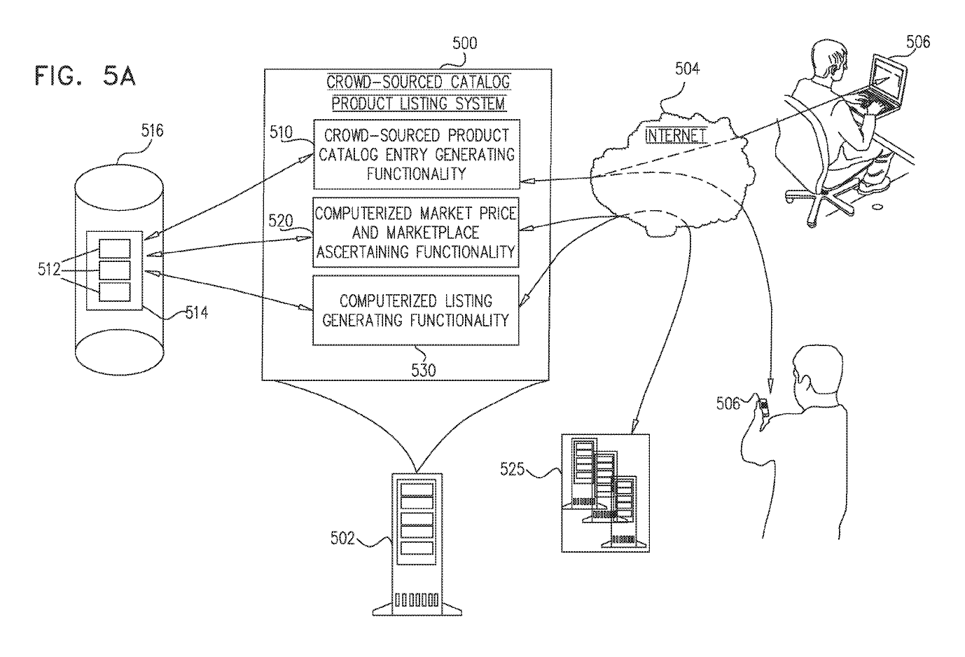

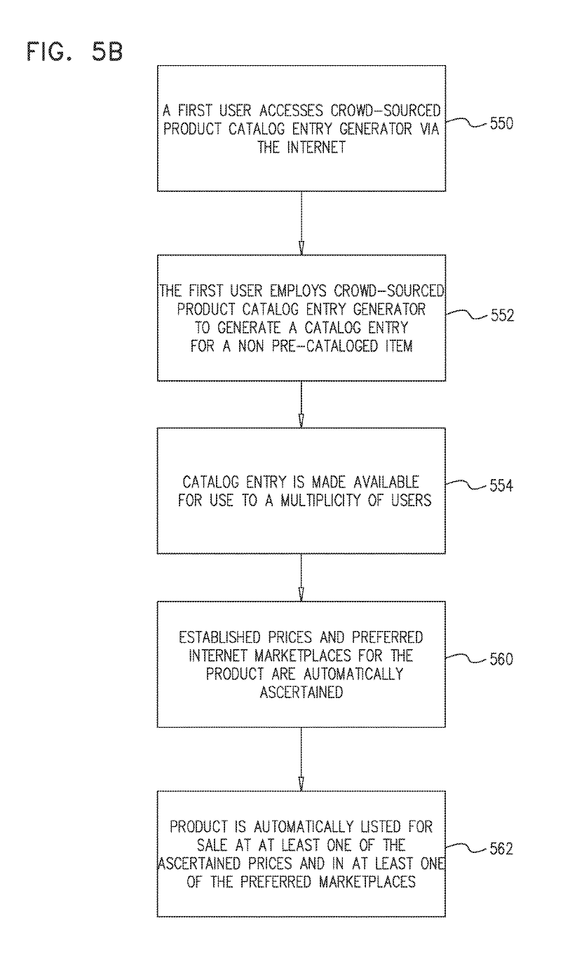

Reference is now made to FIG. 5A, which is a simplified block diagram illustration of a system for employing a crowd-sourced catalog for listing products for sale, constructed and operative in accordance with another preferred embodiment of the present invention, and to FIG. 5B, which is a simplified flowchart illustration of steps in the operation of the system of FIG. 5A.

The system 500 of FIG. 5A preferably resides on a suitable computing device, such as a computer server 502 connected to the internet 504. Users of system 500 typically access system 500 via the internet by employing an internet-enabled computing device 506 such as a desktop or laptop computer, or a mobile communicator device. Users of system 500 typically include, for example, product sellers listing items for sale.

System 500 preferably includes crowd-sourced product catalog entry generating functionality 510 operable for enabling users of system 500 to generate structured, multi-language catalog entries 512 in a crowd-sourced product catalog 514, each of catalog entries 512 corresponding to a product. Crowd-sourced product catalog 514 is preferably stored in a product catalog database 516 accessible to system 500. Catalog entries 512 may be employed, for example, for listing a product for sale, for requesting to purchase a product described therein, for requesting information pertaining to the described therein, for generating a collectors' catalog, for generating a sub-catalog forming a part of a larger product catalog which catalog may not be crowd-sourced, for requesting updates pertaining to demand for the product described therein and for requesting updates pertaining to product availability of the product described therein.

Crowd-sourced product catalog generating functionality 510 typically provides a structured data format for preparing catalog entries for non pre-cataloged items, such as used items for which catalog entries typically do not pre-exist in crowd-sourced product catalog 514. A preferred system for generating catalog entries for non pre-cataloged items is described in U.S. Patent Publication No. 2012/0109786. Alternatively, any suitable system for generating catalog entries may be used.

System 500 also preferably includes computerized market price and marketplace ascertaining functionality 520 operable for automatically ascertaining at least one of established prices and preferred internet marketplaces 525 for the products described in catalog entries 512. System 500 preferably further includes computerized listing generating functionality 530 operable for automatically listing the products for sale at at least one of the ascertained prices and in at least one of the preferred marketplaces 525.

Turning to FIG. 5B, it is shown that a first individual wishing to generate a catalog entry in the crowd-sourced product catalog typically initially accesses crowd-sourced product catalog entry generator 510 of FIG. 5A via the internet (550) and employs crowd-sourced product catalog entry generator 510 to generate a catalog entry corresponding to a product (552).

As further shown in FIG. 5B, subsequent to the generation of the catalog entry in the crowd-sourced product catalog, the catalog entry is made available for use to a multiplicity of users (554), allowing for established prices and preferred internet marketplaces for the product to be automatically ascertained (560). Thereafter, the products are automatically listed for sale at at least one of the ascertained prices and in at least one of the preferred marketplaces (562).

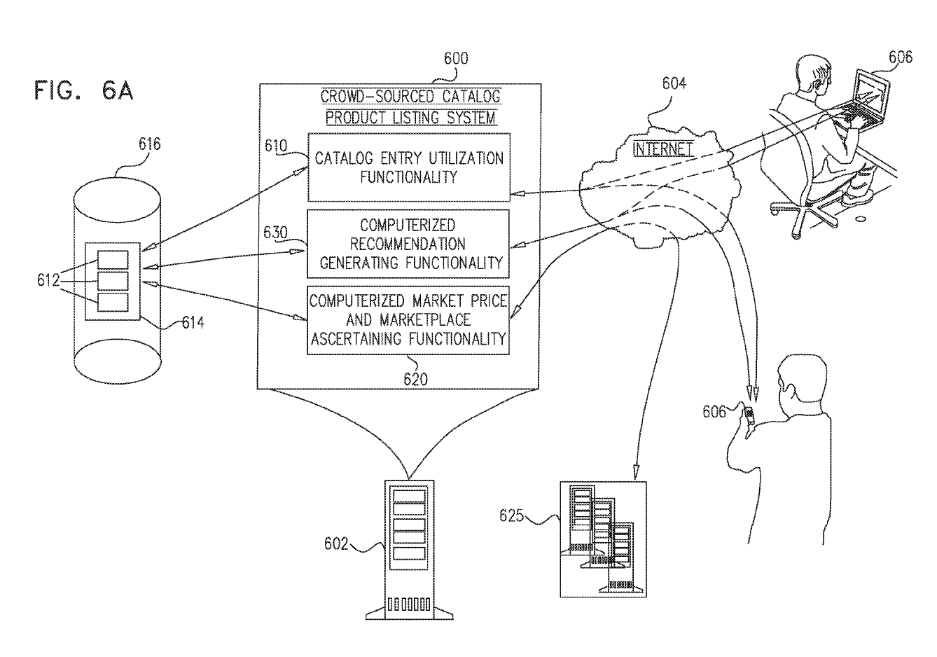

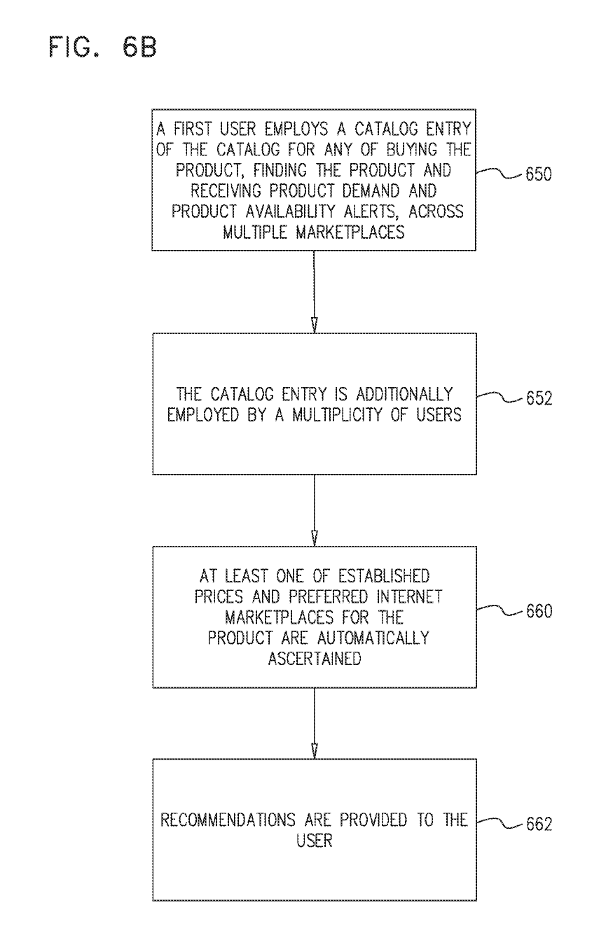

Reference is now made to FIG. 6A, which is a simplified block diagram illustration of a system for employing a crowd-sourced catalog for listing products for sale, constructed and operative in accordance with yet another preferred embodiment of the present invention, and to FIG. 6B, which is a simplified flowchart illustration of steps in the operation of the system of FIG. 6A.

The system 600 of FIG. 6A preferably resides on a suitable computing device, such as a computer server 602 connected to the internet 604. Users of system 600 typically access system 600 via the internet by employing an internet-enabled computing device 606 such as a desktop or laptop computer, or a mobile communicator device. Users of system 600 typically include, for example, product sellers listing items for sale.

System 600 preferably includes catalog entry utilization functionality 610 operable for enabling users of system 600 to employ structured, multi-language catalog entries 612 of a crowd-sourced product catalog 614, each of catalog entries 612 corresponding to a product, for at least one of buying the product, finding the product, receiving demand alerts pertaining to the product and receiving product availability alerts spanning multiple marketplaces. Crowd-sourced product catalog 614 is preferably stored in a product catalog database 616 accessible to system 600.

System 600 also preferably includes computerized market price and marketplace ascertaining functionality 620 operable for automatically ascertaining at least one of established prices and preferred internet marketplaces 625 for the products described in catalog entries 612. System 600 preferably further includes computerized recommendation generating functionality 630 operable for automatically recommending to any of a multiplicity of individuals at least one of the established prices and the preferred marketplaces for at least one of buying the products described in catalog entries 612, finding the products described in catalog entries 612, receiving demand alerts pertaining to the products described in catalog entries 612, and receiving demand alerts pertaining to the products described in catalog entries 612. It is appreciated that the recommendations preferably span the multiple marketplaces.

Turning to FIG. 6B, it is shown that a first individual employs any catalog entry of the crowd-sourced product catalog of FIG. 6A and corresponding to a product, for at least one of buying the product, finding the product, receiving demand alerts pertaining to the product and receiving product availability alerts pertaining to the product and spanning multiple marketplaces (650).

As further shown in FIG. 6B, after the catalog entry is preferably additionally employed by a multiplicity of users (652), for example, to list the product for sale, established prices and preferred internet marketplaces for the product are then automatically ascertained (660). Thereafter, recommendations are provided to the user (662), the recommendations regarding at least one of the established prices and preferred marketplaces for at least one of buying the product, finding the product, receiving demand alerts pertaining to the product and receiving demand alerts pertaining to the product, the recommendations spanning the multiple marketplaces.

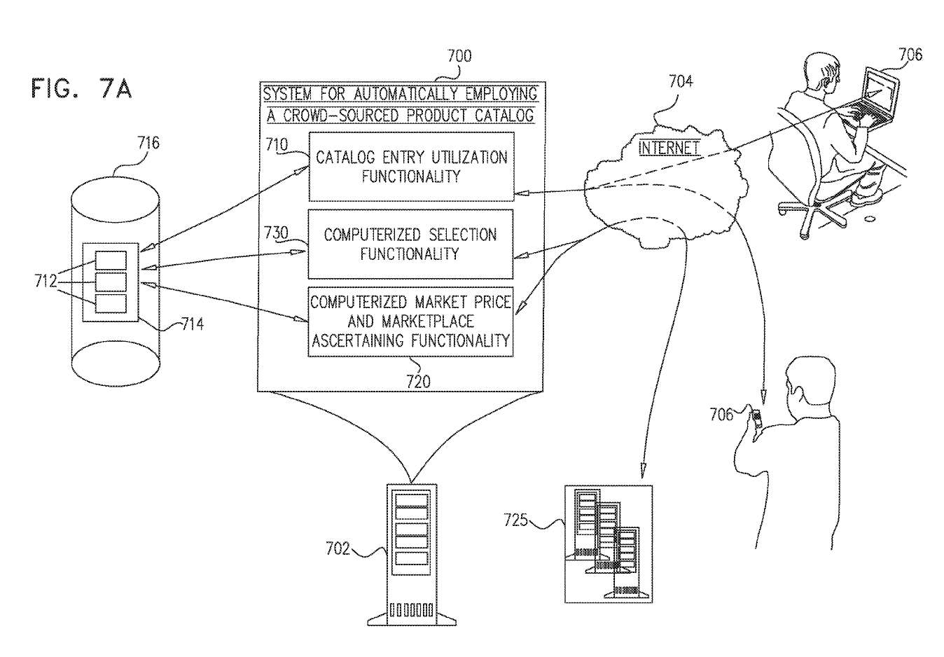

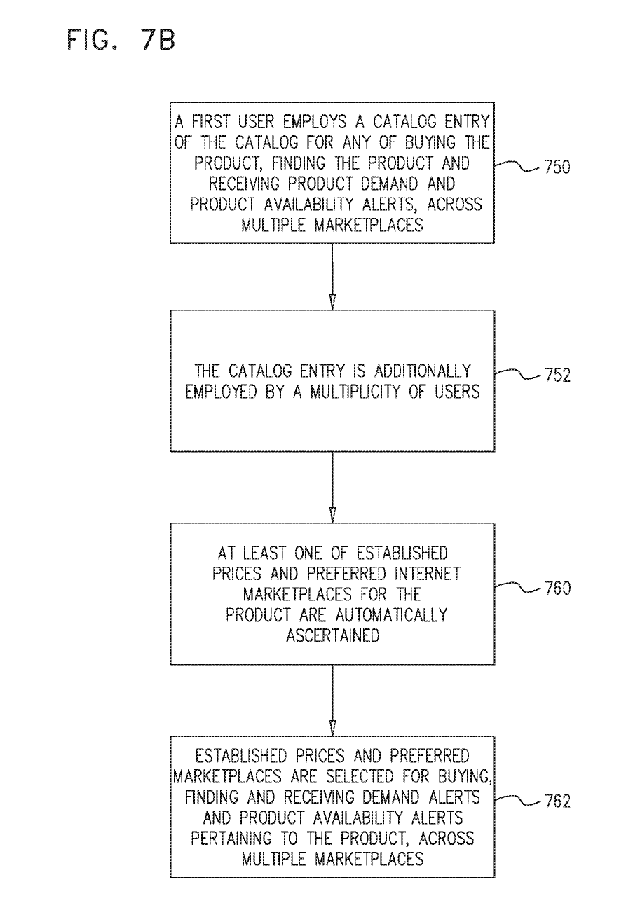

Reference is now made to FIG. 7A, which is a simplified block diagram illustration of a system for automatically employing a crowd-sourced product catalog, constructed and operative in accordance with yet another preferred embodiment of the present invention, and to FIG. 7B, which is a simplified flowchart illustration of steps in the operation of the system of FIG. 7A.

The system 700 of FIG. 7A preferably resides on a suitable computing device, such as a computer server 702 connected to the internet 704. Users of system 700 typically access system 700 via the internet by employing an internet-enabled computing device 706 such as a desktop or laptop computer, or a mobile communicator device. Users of system 700 typically include, for example, product sellers listing items for sale.

System 700 preferably includes catalog entry utilization functionality 710 operable for enabling users of system 700 to employ structured, multi-language catalog entries 712 of a crowd-sourced product catalog 714, each of catalog entries 712 corresponding to a product, for at least one of buying the product, finding the product, receiving demand alerts pertaining to the product and receiving product availability alerts spanning multiple marketplaces. Crowd-sourced product catalog 714 is preferably stored in a product catalog database 716 accessible to system 700.

System 700 also preferably includes computerized market price and marketplace ascertaining functionality 720 operable for automatically ascertaining at least one of established prices and preferred internet marketplaces for the products described in catalog entries 712. System 700 preferably further includes computerized selection functionality 730 operable for automatically selecting at least one of the established prices and the preferred marketplaces for at least one of buying any of the products described in catalog entries 712, finding any of the products described in catalog entries 712, receiving demand alerts pertaining to any of the products described in catalog entries 712, and receiving demand alerts pertaining to any of the products described in catalog entries 712. It is appreciated that the selections preferably span the multiple marketplaces.

Turning to FIG. 7B, it is shown that a first individual employs any catalog entry of the crowd-sourced product catalog of FIG. 7A and corresponding to a product, for at least one of buying the product, finding the product, receiving demand alerts pertaining to the product and receiving product availability alerts pertaining to the product and spanning multiple marketplaces (750).

As further shown in FIG. 7B, after the catalog entry is preferably additionally employed by a multiplicity of users (752), for example, to list the product for sale, established prices and preferred internet marketplaces for the product are then automatically ascertained (760). Thereafter, at least one of the established prices and preferred marketplaces are selected for at least one of buying the product, finding the product, receiving demand alerts pertaining to the product and receiving demand alerts pertaining to the product, the selections spanning the multiple marketplaces (762).

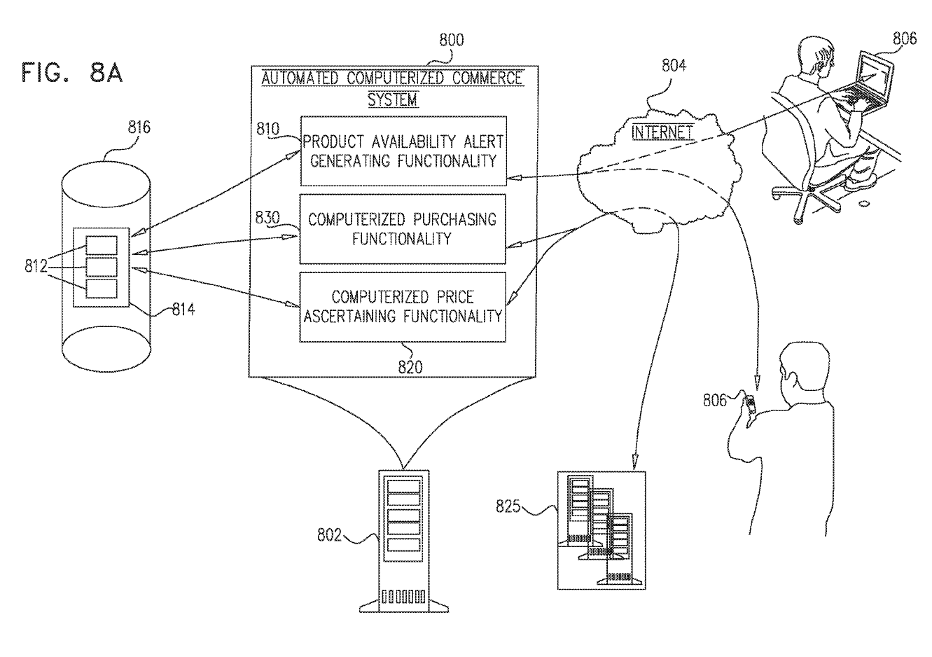

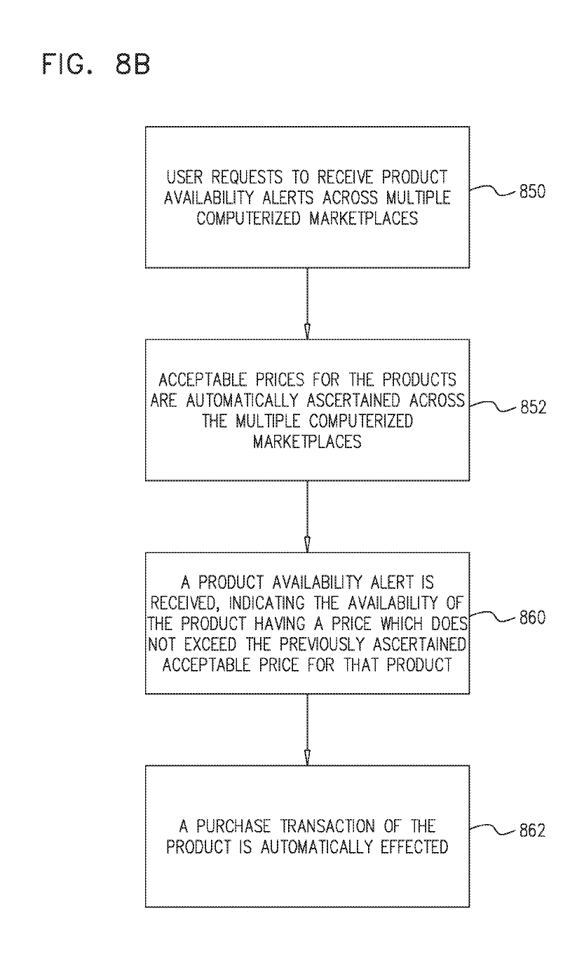

Reference is now made to FIG. 8A, which is a simplified block diagram illustration of a system for automated computerized commerce, constructed and operative in accordance with yet another preferred embodiment of the present invention, and to FIG. 8B, which is a simplified flowchart illustration of steps in the operation of the system of FIG. 8A.

The system 800 of FIG. 8A preferably resides on a suitable computing device, such as a computer server 802 connected to the internet 804. Users of system 800 typically access system 800 via the internet by employing an internet-enabled computing device 806 such as a desktop or laptop computer, or a mobile communicator device. Users of system 800 typically include, for example, product sellers listing items for sale.

System 800 preferably includes product availability alert generating functionality 810 operable for enabling users of system 800 to request and to receive product availability alerts pertaining to any of a multiplicity of products corresponding to a multiplicity of structured, multi-language catalog entries catalog entries 812 of a crowd-sourced product catalog 814. It is appreciated that the product availability alerts preferably span multiple computerized marketplaces.

System 800 also preferably includes computerized price ascertaining functionality 820 operable for automatically ascertaining acceptable prices for any of the multiplicity of products corresponding to catalog entries catalog entries 812 of crowd-sourced product catalog 814 across the multiple computerized marketplaces 825. System 800 preferably further includes computerized purchasing functionality 830 operable for automatically effecting a purchase transaction for at least one of the multiplicity of products corresponding to catalog entries catalog entries 812 of crowd-sourced product catalog 814 when a product availability alert generated by product availability alert generating functionality 810 indicates an availability of the product for purchase at a price which does not exceed a previously ascertained acceptable price for the product.

Turning to FIG. 8B, it is shown that an individual requests to receive product availability alerts pertaining to any a multiplicity of products and spanning multiple computerized marketplaces (850). Thereafter, acceptable prices for the products are automatically ascertained across the multiple computerized marketplaces (852). Responsive to receiving a product availability alert indicating the availability of the product having a price which does not exceed a previously ascertained acceptable price for that product (860), a purchase transaction of the product is automatically effected (862).

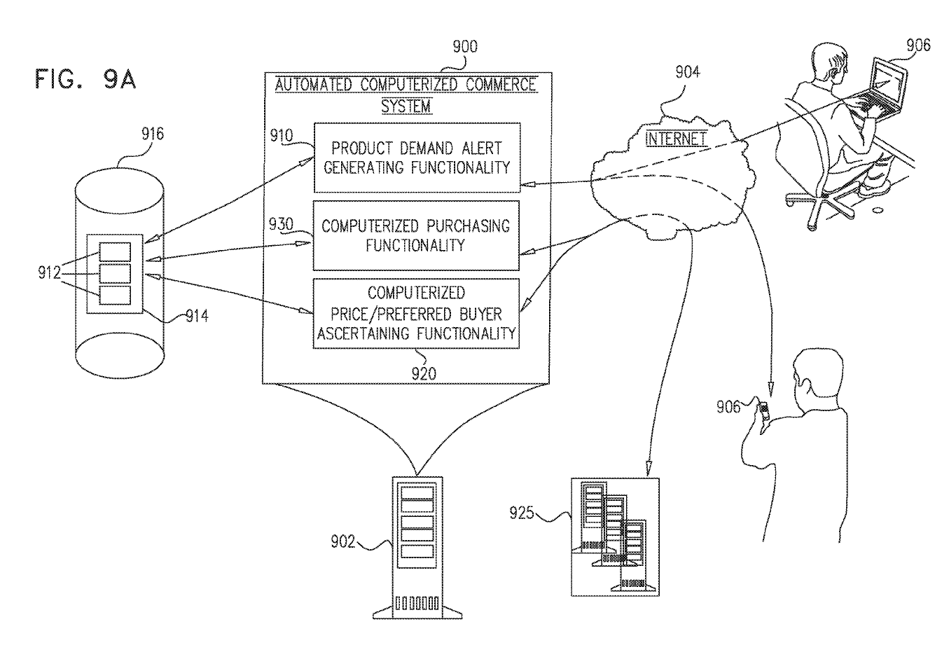

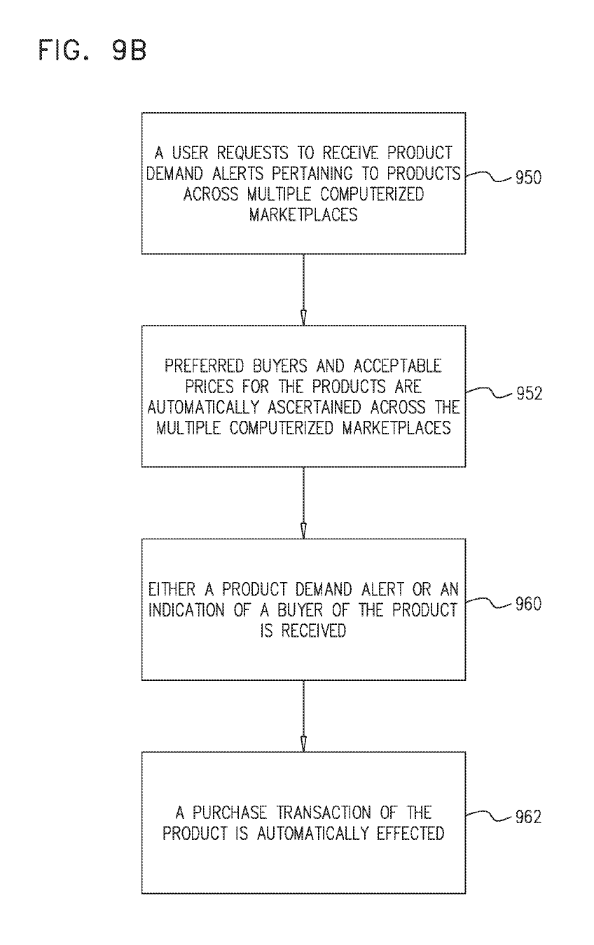

Reference is now made to FIG. 9A, which is a simplified block diagram illustration of a system for automated computerized commerce, constructed and operative in accordance with yet another preferred embodiment of the present invention, and to FIG. 9B, which is a simplified flowchart illustration of steps in the operation of the system of FIG. 9A.

The system 900 of FIG. 9A preferably resides on a suitable computing device, such as a computer server 902 connected to the internet 904. Users of system 900 typically access system 900 via the internet by employing an internet-enabled computing device 906 such as a desktop or laptop computer, or a mobile communicator device. Users of system 900 typically include, for example, product sellers listing items for sale.

System 900 preferably includes product demand alert generating functionality 910 operable for enabling users of system 900 to request and to receive product demand alerts pertaining to any of a multiplicity of products corresponding to a multiplicity of structured, multi-language catalog entries catalog entries 912 of a crowd-sourced product catalog 914. It is appreciated that the product availability alerts preferably span multiple computerized marketplaces.

System 900 also preferably includes computerized price/preferred buyer ascertaining functionality 920 operable for automatically ascertaining at least one of a preferred buyer and an acceptable price for any of the multiplicity of products corresponding to catalog entries catalog entries 912 of crowd-sourced product catalog 914 across the multiple computerized marketplaces.

System 900 preferably further includes computerized purchasing functionality 930 operable for automatically effecting a purchase transaction for at least one of the multiplicity of products corresponding to catalog entries catalog entries 912 of crowd-sourced product catalog 914 when a product demand alert generated by product demand alert generating functionality 910 indicates demand for the product at a price which is not less than a previously ascertained acceptable price for the product as ascertained by computerized price/preferred buyer ascertaining functionality 920, or when a preferred buyer of the product meeting pre-defined criteria is identified by computerized price/preferred buyer ascertaining functionality 920.

Turning to FIG. 9B, it is shown that an individual requests to receive product demand alerts pertaining to any a multiplicity of products and spanning multiple computerized marketplaces (950). Thereafter, preferred buyers and acceptable prices for the products are automatically ascertained across the multiple computerized marketplaces (952). Responsive to either receiving a product demand alert indicating the demand for the product at a price which is not less than a previously ascertained acceptable price for the product or indicating a buyer of the product meeting pre-defined criteria (960), a purchase transaction of the product is automatically effected (962).

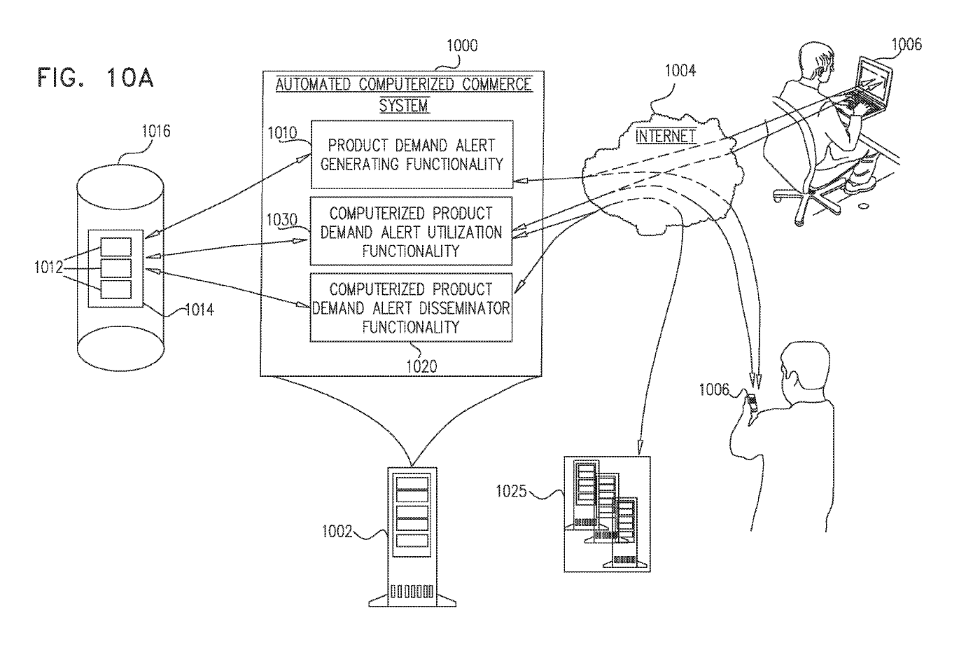

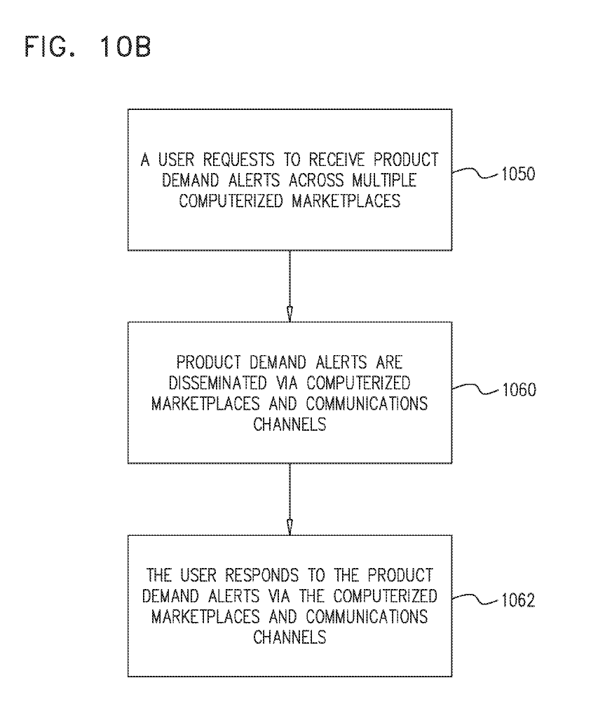

Reference is now made to FIG. 10A, which is a simplified block diagram illustration of a system for automated computerized commerce, constructed and operative in accordance with yet another preferred embodiment of the present invention, and to FIG. 10B, which is a simplified flowchart illustration of steps in the operation of the system of FIG. 10A.

The system 1000 of FIG. 10A preferably resides on a suitable computing device, such as a computer server 1002 connected to the internet 1004. Users of system 1000 typically access system 1000 via the internet by employing an internet-enabled computing device 1006 such as a desktop or laptop computer, or a mobile communicator device. Users of system 1000 typically include, for example, product sellers listing items for sale.

System 1000 preferably includes product demand alert generating functionality 1010 operable for enabling users of system 1000 to request and to receive product demand alerts pertaining to any of a multiplicity of products corresponding to a multiplicity of structured, multi-language catalog entries catalog entries 1012 of a crowd-sourced product catalog 1014.

System 1000 also preferably includes computerized product demand alert disseminator functionality 1020 operable for disseminating the product demand alerts generated by product demand alert generating functionality 1010 via at least one of a multiplicity of computerized marketplaces and communications channels 1025. It is appreciated that computerized product demand alert disseminator functionality 1020 may utilize a crowd-sourced product catalog such as the catalog described in U.S. Patent Publication No. 2012/0109786 for disseminating product demand alerts. Alternatively, any suitable method for disseminating product demand alerts may be used.

System 1000 preferably further includes computerized product demand alert utilization functionality 1030 operable for enabling any of the users of system 1000 to respond to the product demand alerts via at least one of computerized marketplaces and communications channels 1025. It is appreciated that computerized product demand alert utilization functionality 1030 may utilize a crowd-sourced product catalog such as the catalog described in U.S. Patent Publication No. 2012/0109786 for enabling individuals to respond to the product demand alerts. Alternatively, any suitable method for enabling individuals to respond to product demand alerts may be used.

Turning to FIG. 10B, it is shown that an individual requests to receive product demand alerts pertaining to any a multiplicity of products and spanning multiple computerized marketplaces (1050). Thereafter, product demand alerts are disseminated via at least one of a multiplicity of computerized marketplaces and communications channels (1060). Thereafter, the individual can respond to the product demand alerts via at least one of the multiplicity of computerized marketplaces and communications channels (1062).

It will be appreciated by persons skilled in the art that the present invention is not limited by what has been particularly shown and described hereinabove. Rather the scope of the present invention includes both combinations and subcombinations of the various features described hereinabove as well as modifications thereof which would occur to persons skilled in the art upon reading the foregoing description and which are not in the prior art.

1-60. (canceled)

61. A method for employing a crowd-sourced catalog for listing products for sale, said method comprising:
enabling multiple individuals to generate structured, multi-language catalog entries in said crowd-sourced product catalog, each of said catalog entries corresponding to a product;
automatically ascertaining at least one of established prices and preferred internet marketplaces for said products; and
automatically recommending to any of a multiplicity of individuals at least one of said established prices and said preferred marketplaces for listing said products for sale.

62. A method for employing a crowd-sourced product catalog for listing products for sale according to claim 61 and also comprising:
enabling a multiplicity of individuals to employ said catalog entries for listing products for sale;
automatically ascertaining at least one of established prices and preferred internet marketplaces for said products for sale; and
automatically listing said products for sale at at least one of said ascertained prices, to at least one of said preferred buyers and in at least one of said preferred marketplaces.

63. A method for employing a crowd-sourced product catalog for listing products for sale according to claim 61 and also comprising:
enabling a multiplicity of individuals to employ said catalog entries for listing products for sale;
automatically ascertaining at least one of established prices, preferred buyers and preferred internet marketplaces for said products; and
automatically recommending to said multiplicity of individuals at least one of said established prices, preferred buyers and said preferred marketplaces for listing said products for sale.

64. A method for employing a crowd-sourced product catalog for listing products for sale according to claim 61 and also comprising:
enabling any of a multiplicity of individuals to request and to receive product availability alerts pertaining to any a multiplicity of products corresponding to said catalog entries and spanning multiple computerized marketplaces;
automatically ascertaining acceptable prices for said products across said multiple computerized marketplaces; and
automatically effecting a purchase transaction when a product availability alert indicates the availability of a product having a price which does not exceed a previously ascertained acceptable price for said product.

65. A method for employing a crowd-sourced product catalog for listing products for sale according to claim 61 and also comprising:
enabling any of a multiplicity of individuals to request and receive product demand alerts pertaining to any of a multiplicity of products corresponding to said catalog entries and spanning multiple computerized marketplaces;
automatically ascertaining at least one of a preferred buyer and an acceptable price for said products across said multiple computerized marketplaces; and
automatically effecting a purchase transaction for at least one of said products when at least one of the following takes place:
a product demand alert indicates demand for said product at a price which is not less than a previously ascertained acceptable price for said product; and
a buyer of said product meeting pre-defined criteria is identified.

66. A method for employing a crowd-sourced product catalog for listing products for sale according to claim 61 and also comprising:
enabling any of a multiplicity of individuals to request and receive product demand alerts pertaining to any of a multiplicity of products corresponding to said catalog entries;
disseminating said product demand alerts via at least one of a multiplicity of computerized marketplaces and communications channels; and
enabling any of said multiplicity of individuals to respond to said product demand alerts via at least one of said multiplicity of computerized marketplaces and communications channels.

67. A method for employing a crowd-sourced product catalog for listing products for sale according to claim 66 and wherein said enabling any of said multiplicity of individuals to respond to said product demand alerts comprises at least one of:
listing a product in demand for sale;
generating a catalog of products in demand; and
effecting a sale of a product in demand.

68. A method for employing a crowd-sourced product catalog for listing products for sale according to claim 61 and wherein said catalog entries, each of said catalog entries corresponding to a product, are configured to be employed for generating at least one of the following:
new listings of products for sale;
new catalog entries;
requests to buy products;
requests for product information;
collectors' catalogs;
sub-catalogs forming part of a larger catalog;
information contributions;
requests to receive product demand updates; and
product availability updates.

69. A method for employing a crowd-sourced product catalog for listing products for sale according to claim 61 and wherein said catalog entries, each of said catalog entries corresponding to a product, are configured to be employed for generating at least two of the following:
new listings of products for sale;
new catalog entries;
requests to buy products;
requests for product information;
collectors' catalogs;
sub-catalogs forming part of a larger catalog;
information contributions;
requests to receive product demand updates; and
product availability updates.

70. A method for employing a crowd-sourced product catalog for listing products for sale according to claim 61 and wherein said catalog entries are used to create at least three of the following:
new listings for sale;
new catalog entries;
product buy requests;
product information requests;
collectors' catalogs;
sub-catalogs which form part of a larger catalog;
product information requests;
information contributions;
requests for updates on product demand; and
updates on product availability.

71. A system for employing a crowd-sourced catalog for listing products for sale, said system comprising:
crowd-sourced product catalog entry generating functionality operable for enabling multiple individuals to generate structured, multi-language catalog entries in said crowd-sourced product catalog, each of said catalog entries corresponding to a product;
computerized market price and marketplace ascertaining functionality operable for automatically ascertaining at least one of established prices and preferred internet marketplaces for said products; and
computerized recommendation generating functionality operable for automatically recommending to any of a multiplicity of individuals at least one of said established prices and said preferred marketplaces for listing said products for sale.

72. A system for employing a crowd-sourced product catalog for listing products for sale according to claim 71 and also comprising:
computerized market price and marketplace ascertaining functionality operable for automatically ascertaining at least one of established prices, preferred buyers and preferred internet marketplaces for products corresponding to said catalog entries; and
computerized listing generating functionality operable for at least one of automatically listing said products for sale at at least one of said ascertained prices and in at least one of said preferred marketplaces.

73. A system for employing a crowd-sourced product catalog for listing products for sale according to claim 71 and also comprising:
catalog entry utilization functionality operable for enabling any of a multiplicity of individuals to employ any catalog entry of said crowd-sourced product catalog corresponding to a product, for at least one of:
buying said product;
finding said product;
receiving demand alerts pertaining to said product; and
receiving product availability alerts spanning multiple marketplaces;
computerized price/marketplace ascertaining functionality operable for automatically ascertaining at least one of established prices and preferred internet marketplaces for each said product; and
computerized recommendation generating functionality operable for automatically recommending to any of said multiplicity of individuals at least one of said established prices and preferred marketplaces for at least one of:
buying said product;
finding said product;
receiving demand alerts pertaining to said product; and
receiving demand alerts pertaining to said product;
said recommendations spanning said multiple marketplaces.

74. A system for employing a crowd-sourced product catalog for listing products for sale according to claim 71 and also comprising:
product availability alert generating functionality operable for enabling any of a multiplicity of individuals to request and to receive product availability alerts pertaining to any a multiplicity of products corresponding to said catalog entries and spanning multiple computerized marketplaces;
computerized price ascertaining functionality operable for automatically ascertaining acceptable prices for said products across said multiple computerized marketplaces; and
computerized purchasing functionality operable for automatically effecting a purchase transaction for at least one of said products when a product availability alert indicates an availability of said product for purchase at a price which does not exceed a previously ascertained acceptable price for said product.

75. A system for employing a crowd-sourced product catalog for listing products for sale according to claim 71 and also comprising:
product demand alert generating functionality operable for enabling any of a multiplicity of individuals to request and receive product demand alerts pertaining to any of a multiplicity of products corresponding to said catalog entries and spanning multiple computerized marketplaces;
computerized price/preferred buyer ascertaining functionality operable for automatically ascertaining at least one of a preferred buyer and an acceptable price for said products across said multiple computerized marketplaces; and
computerized purchasing functionality operable for automatically effecting a purchase transaction for at least one of said products when at least one of the following takes place:
a product demand alert indicates demand for said product at a price which is not less than a previously ascertained acceptable price for said product; and
a preferred buyer of said product meeting pre-defined criteria is identified.

76. A system for employing a crowd-sourced product catalog for listing products for sale according to claim 71 and also comprising:
computerized product demand alert generating functionality operable for enabling any of a multiplicity of individuals to request and receive product demand alerts pertaining to any of a multiplicity of products corresponding to said catalog entries;
computerized product demand alert disseminator functionality operable for disseminating said product demand alerts via at least one of a multiplicity of computerized marketplaces and communications channels; and
computerized product demand alert utilization functionality operable for enabling any of said multiplicity of individuals to respond to said product demand alerts via at least one of said multiplicity of computerized marketplaces and communications channels.

77. A system for employing a crowd-sourced product catalog for listing products for sale according to claim 76 and wherein said enabling any of said multiplicity of individuals to respond to said product demand alerts comprises at least one of:
listing a product in demand for sale;
generating a catalog of products in demand; and
effecting a sale of a product in demand.

78. A system for employing a crowd-sourced product catalog for listing products for sale according to claim 71 and wherein said catalog entries, each of said catalog entries corresponding to a product, are configured to be employed for generating at least one of the following:
new listings of products for sale;
new catalog entries;
requests to buy products;
requests for product information;
collectors' catalogs;
sub-catalogs forming part of a larger catalog;
information contributions;
requests to receive product demand updates; and
product availability updates.

79. A system for employing a crowd-sourced product catalog for listing products for sale according to claim 71 and wherein said catalog entries, each of said catalog entries corresponding to a product, are configured to be employed for generating at least two of the following:
new listings of products for sale;
new catalog entries;
requests to buy products;
requests for product information;
collectors' catalogs;
sub-catalogs forming part of a larger catalog;
information contributions;
requests to receive product demand updates; and
product availability updates.

80. A system for employing a crowd-sourced product catalog for listing products for sale according to claim 71 and wherein said catalog entries, each of said catalog entries corresponding to a product, are configured to be employed for generating at least three of the following:
new listings of products for sale;
new catalog entries;
requests to buy products;
requests for product information;
collectors' catalogs;
sub-catalogs forming part of a larger catalog;
information contributions;
requests to receive product demand updates; and
product availability updates.

81-184. (canceled)
